(19) United States
(12) Patent Application Publication
(10) Pub. No.: US 2005/0074526 A1
(43) Pub. Date: Apr. 7, 2005

(54) Method for a consumer to individually flavor his own dairy dessert

(75) Inventor: Tony M. Pearce, Alpine, UT (US)

Correspondence Address: Parsons Behle & Latimer;Suite 1800, 201 South Main Street, P.O. Box 45898, Salt Lake City, UT, 84111, US

(73) Assignee: EdiZONE, LC

(21) Appl. No.: 10/934,336

(22) Filed: Sep. 2, 2004

Related U.S. Application Data
(63) Continuation-in-part of application No. 10/325,721, filed on Dec. 20, 2002.
(60) Provisional application No. 60/356,279, filed on Feb. 11, 2002.
(60) Provisional application No. 60/368,821, filed on Apr. 1, 2002.

(51) Int. Cl. A01K 1/00

(52) U.S. Cl. 426/89

(57) ABSTRACT

Methods and substances for a consumer to individually flavor his own dairy dessert, such as ice cream, frozen yogurt and cheesecake, by adding flavorful and tasty spray or liquid thereto.

### PRIORITY

This application claims priority to and benefit of U.S. Provisional Patent Application Ser. No. 60/449,922 filed on Sep. 2, 2003.

This application is a continuation-in-part patent application of U.S. patent application Ser. No. 10/325,721 filed on Dec. 20, 2002, which claims priority to U.S. Provisional Patent Application Ser. No. 60/356,279 filed on Feb. 11, 2002 and U.S. Provisional Patent Application Ser. No. 60/368,821 filed on Apr. 1, 2002.

Each of the foregoing is hereby incorporated by reference in its entirety.

### BACKGROUND

This disclosure relates to highly concentrated liquid flavorings that may be added to food items by the consumer to create or enhance a desired flavoring.

### SUMMARY

Use of highly concentrated liquid flavorings can create a heretofore unexpected and surprising flavor that is highly desirable to and appreciated by the consumer, thereby making relatively unpalatable foods palatable, and making even popular foods even more attractive.

### BRIEF DESCRIPTION OF DRAWINGS

FIG. 1 depicts flavorful drops which can be used by a consumer to create a beverage having a specific desired taste.

FIG. 2 depicts drops which a user can utilize to flavor a breakfast cereal.

FIG. 3 depicts tongue drops which a consumer can use to experience a flavorful experience.

FIG. 4 depicts drops which can be used to enhance the flavor of waffles.

FIG. 4a depicts drops which can be used to enhance the flavor of pancakes.

FIG. 5 depicts drops which can be used to flavor ice cream.

FIG. 5a depicts drops which can be used to flavor cheesecake.

FIG. 6 depicts drops which can be used to flavor milk.

### DETAILED DESCRIPTION

The detailed description contains several related disclosures for the reader to consider.

Creating/Flavoring Drinks Via Highly Concentrated Liquid Unit Doses

Children and adults love drinks with interesting, strong or unique flavor such as fruit-flavored punch, chocolate milk, or hot chocolate made from powdered mixes. However, use of these powdered drink mixes is often a messy process, particularly when children make the drinks. For example, typical punch comes in packets with and without sugar. In the case of the packet without sugar, there is the potential to spill the powder, especially during the process of ripping open the paper packet and pouring it in. Then there is additional potential for spilling the sugar, which must come from a separate container. In the case of the packet that includes sugar, the bulk is large and the potential for spillage even greater than from the small packs that have no sugar. There exists a need for a means for a child to make such drinks without the potential for powder spillage.

Another problem is that such powder mixes for drinks often call for the user to measure out ingredients including water or milk, sugar, and the powdered mix. For example, when making chocolate milk, the child must measure out or estimate a certain volume of milk, then measure out a certain volume of powder. Users, especially children, can make mistakes in measuring, which can make drinks that are too weak or too strong or in which the ingredients are otherwise misproportioned. There exists a need for a simpler and more fool-proof means for ensuring the correct proportionality of ingredients.

Another problem with for example punch mixes is that the packets are made to result in a large amount of punch, typically two quarts per packet. In today's small families with only one or two children, after satisfying their drink wants, there would remain a large amount of punch to store in the refrigerator, a place where space is at a premium. There exists a need for a simple and easy means to make individual drink servings for a single user such as one child.

Another problem with such drink mixes is that, for example when two quarts of punch are made up for a group of five children at play, all five have to drink the same flavor. It may be difficult to please all five children with a single flavor due to individual flavor preferences. There exists a need for a simple and easy means to allow each person in a group to have his or her own choice of flavor. All of these needs are met in the drink drops.

Individual preferences for drinks vary widely. For example, in coffee, some users prefer it black, some prefer it with cream, some with sugar, and some with cream and sugar. These ingredients are all generally available where hot coffee is made. However, some users would prefer to have added flavors in their coffee, for example mocha raspberry, or almond flavoring. There exists a need for a simple, easy, non-messy way to put a pre-measured amount of such flavorings into hot coffee, or into hot chocolate, or into chocolate milk, or into cold plain milk, etc. As another example, soda drinks are widely available, but there exists a need for a simple, easy, non-messy way to put a pre-measured amount of additional flavoring into a soda drink. For example, putting cherry flavoring into a cola drink, or putting vanilla flavoring into a root beer drink. The same need can apply to fruit juices, where for example an individual's preference may be to add cranberry flavoring to the apple juice provided in a lunch provided by an elementary school. There exists a need for a simple, easy, non-messy way to put a pre-measured amount of additional flavoring into a juice drink or into any kind of drink.

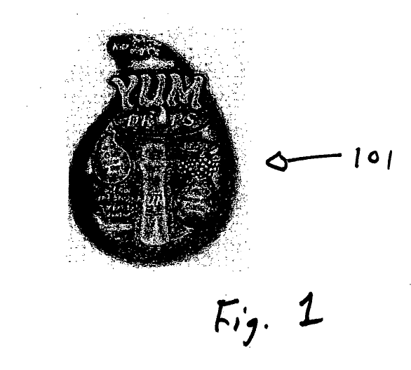

Referring to FIG. 1, drink drops 101 branded YUM DROPS have been developed that are a highly concentrated liquid in a container which delivers small measured unit doses, such as a container with a spray head, such as a finger pump, or such as a container with a dropper head to create drops when the container is up-ended and squeezed, the concentrated liquid being of a nature to mix with the desired base liquid (water, milk, coffee, soda, juice, etc.) and comprising ingredients which when stirred into a predetermined amount of the base liquid will provide a drink with the desired qualities (punch, hot chocolate, chocolate milk, better-flavored coffee, better-flavored soda, better-flavored juice, etc.). The spray head, dropper head, etc. is configured to give relatively uniform size dose in each activation of the dispenser, so that the effect of a single spray or drop or etc. on a given amount of base liquid is relatively predictable. The ingredients can include flavorants, acids, sweeteners, colorants, thickeners, surfactants, humectants, and any other type of ingredient as desired to affect the properties of the drinks. Flavorants must be included to create a satisfying beverage.

Example: The following ingredients, measured in grams, are put, via a multiple predetermined number of sprays from a small spray bottle with a finger pump, into a 4-oz glass of water and swirled or stirred. The grape flavor is #856.193 from Flavors of North America, Carol Stream, Ill.

| | |
|---|---|
| Grape Flavor | 0.062 |
| Acesulfame Potassium | 0.014 |
| Aspartame | 0.014 |
| Sucralose | 0.005 |
| Citric Acid | 0.129 |

This results in a refreshing grape flavored, sugar-free drink. Or, twice as many sprays are put into an eight-ounce glass of water, or three times as many sprays into a twelve-ounce glass of water. No powder exists to be scattered, and the directions are easy enough for a child that can count to low numbers to understand. No leftovers exist to be stored in the refrigerator. With a small spray-pump container (e.g., 10 ml) for each of several flavors stored in a kitchen cupboard, each child in a group of five can choose his or her own flavor.

Other examples of drink drops include cherry drops in Sprite, lemon drops in Pepsi, caramel-vanilla drops in Coke, almond mocha, French vanilla or amarete drops in coffee, or lemon-raspberry drops in iced tea.

As desired, each individual consumer can create his own beverage flavoring by selecting a unique combination of beverage base and drink drops. Multiple drink drops may be mixed into a beverage base to provide multiple flavors in the same beverage. In a large family, each child can have his own flavor. And there is no added work or mess for parents since children will delight in mixing their own flavored drinks.

Alternatively, the same example solution can be put into a squeezable plastic container (such as are used for eye drops and ear drops and food coloring drops) and a pre-determined number of drops per fluid ounce of base liquid are added and swirled or stirred. An advantageous type of dropper bottle would be a “no-drip” design (such as that used by Gel Spice Co., Inc. of Bayonne, N.J. for its Spice Supreme Food Colors). Another advantageous feature is that a given dropper bottle container would have just enough to use in two quarts of base liquid, since many U.S. consumers have two-quart pitchers. Then the user has the option of making a whole pitcher by squeezing out all the contents, or to make individual servings by the drop method.

In either example, artificial (or potent natural) sweeteners and concentrated flavors are used to achieve the aspect of the invention of the liquid being highly concentrated. The high concentration is particularly desirable when the container is to be carried in pocket or purse, since the size of the bottle is small. It would also be difficult to have a reasonable number of sprays or drops for even an individual serving if the liquid were not highly concentrated or were to use non-potent natural sweeteners such as sucrose or corn syrup or etc.

Either of these two liquid measured dosage forms, or other forms that meet the description of a highly concentrated measured liquid dosage form for creating or enhancing a drink, can be used, and can be formulated with flavorants and other ingredients that meet the needs of the user whether added to water, milk, coffee, soda, juice or other liquids.

In summary, the drink drops may be contained in a suitable container that has a reservoir for holding the liquid drink drops. A dispenser may be included, such as a nozzle on the container if the container is a squeezable bottle so that squeezing the bottle forces a quantity of drink drops out of the bottle. Or a pump, spray or other dispensing mechanism may be included to move drink drops from the container reservoir to a beverage container such as a glass. Some desirable containers will be small enough to conveniently fit into a consumer's pocket for transportation, and may have a greatest dimension of less than 4 inches, less than 3 inches, or less than 2 inches.

The drink drops contained in the container are generally highly concentrated and flavorful, so much so that they would ordinarily be too strong for direct consumption. Consequently they are moved from the container to a beverage base, such as water, milk, juice, coffee, tea, soft drinks, alcoholic beverages, beer, etc. The drink drops are diluted in the beverage base to an extent that they are not excessively strong to the taste bud, but not so much that they are not noticeable to a consumer. Typically movement of the drink drops to the beverage base is carried out at the point of consumption, such as at a consumer's home, in the consumer's workplace, in the consumer's car, etc. Also, movement of the drink drops to the beverage base is ordinarily carried out by the consumer himself, or by a server (such as a waiter in a restaurant).

Next, the drink drops are mixed with the beverage base to a generally uniform concentration throughout the beverage base. Next the flavored beverage is ingested and the flavor sensation created by the drink drops is enjoyed by the consumer.

The drink drops may include any desirable ingredients, such as sweeteners, acids, preservatives, thickeners, colorants, etc. The sweeteners may be artificial or natural sugars. The drink drops will normally have a flavoring concentration that they will be used in a ratio of not more than 0.015 ounce of drink drops per ounce of beverage base, and typically not more than 0.008 ounce of drink drops per ounce of beverage base.

As used herein, “drink drops” are a highly concentrated and flavored liquid used to flavor a beverage base, the drink drops being flowable from a container into a beverage base. The definition of drink drops excludes both powdered and paste drinks.

Example drink drops formulations are as follow. They can be used in coffee, tea, soda or other beverage bases as desired.

NOTES
DRINK DROPS
Especially for coffee, tea, and soda
CHERRY and GRAPE FLAVORS

| Wt. | | | |
|---|---|---|---|
| (gms) | Material | Identification | Source |
| GRAPE | | | |
| 1.73 | flavor | #856.376/WC | Flavors of North |
| | | | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.01 | food coloring | FD& C Red #40 | Spectrum |
| | | Lot # RG1249 | |
| 0.01 | food coloring | FD& C Blue # 1 | Spectrum |
| | | Lot # RG0809 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |
| CHERRY | | | |
| 1.73 | flavor | #EZ | Flavors of North |
| | | 0003U.825/WC | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Red #40 | Spectrum |
| | total | Lot # RG1249 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |

Other example drink drops are as follow. They may be used for children's beverages or for other beverages as desired.

YUM DROPS FOR MAKING DRINKS
SUCH AS CHILDRENS DRINKS
CHERRY, GRAPE, RASPBERRY,
BLUEBERRY and STRAWBERRY FLAVORS

| Wt.(gms) | Material | Identification | Source |
|---|---|---|---|
| STRAWBERRY | | | |
| 1.73 | flavor | #EZ | Flavors of North |
| | | 0004U.915/WC | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Red #40 | Spectrum |
| | total | Lot # RG1249 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |
| BLUEBERRY | | | |
| 1.73 | flavor | # 809.132/WC | Flavors of North |
| | | | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue # 1 | Spectrum |
| | | Lot # RG0809 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |
| GRAPE | | | |
| 1.73 | flavor | #856.376/WC | Flavors of North |
| | | | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.01 | food coloring | FD& C Red #40 | Spectrum |
| | | Lot # RG1249 | |
| 0.01 | food coloring | FD& C Blue # 1 | Spectrum |
| | | Lot # RG0809 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |
| RASPBERRY | | | |
| 1.73 | flavor | # 906.558/WC | Flavors of North |
| | | | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue # 1 | Spectrum |
| | | Lot # RG0809 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |
| CHERRY | | | |
| 1.73 | flavor | #EZ | Flavors of North |
| | | 0003U.825/WC | America, Inc |
| 0.04 | ascorbic acid | Lot # 2959-J2 | Nature's Life |
| 0.10 | ace-K | Sunett Brand | Nutrinova, Inc. |
| | | Sweetner-sample | |
| 0.41 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Red #40 | Spectrum |
| | total | Lot # RG1249 | |
| 2.66 | distilled water | | Western Family |
| 0.64 | K-citrate | Lot # 260204-F | Stauber |
| | | | Performance |
| 3.82 | citric acid | CAS 77-92-9 | High Valley |
| | | | Chemical, Inc. |

It was found that if a low pH formulation was used, some deterioration of the sweeteners and flavor occurred. It was found that when a buffer was used in a specific order of addition and in a ratio of 6:1, acid to buffer, the pH was increased and the formulation was stabilized. It was also noted that the potassium citrate buffer performed better than sodium citrate buffer. It was also noted that aspartame is not stable at a low pH. A combination of Acesulfame potassium and Sucrlose perform well at low pH to create a stable formula. Due to the low pH it is not necessary to include a preservative in the formulation. This applies to all of the drops, sprays and flavorings herein.

Liquid Cereal Flavorings

Children and adults love cold and hot cereals that are sweetened and that have fruit on or in them. However, the sweetness of cereal generally comes from sugar which many feel is not healthful in the large amounts that come on or in the cereal or are put on or in the cereal by the consumer. The fruit is expensive and difficult to keep fresh and difficult or messy to apply. For example, children may cut themselves with a sharp knife while attempting to slice strawberries onto cereal. As another example, a container of expensive blueberries may go moldy before all of the blueberries are used. The desired fruit may not be in season and thus difficult to obtain. Using fruit also creates a limitation on flavors to those that may desire other flavors on their cereal than fruit flavors. Fruit can also take up valuable refrigerator or counter space, especially if it is desirable to make a variety of fruits available to family members. Cutting a banana or other ripe fruit can be a messy process that leaves the hands slimy, and leaves trash to dispose of such as banana peels that can attract fruit flies. In contrast, dehydrated fruit in the cereal usually provides a less than satisfactory taste or texture. There exists a need for a simple, sugar-free or reduced sugar, non-messy, inexpensive, low-space-consuming, non-spoiling, non-dangerous, always available, high-flavor-variety, low-trash means of sweetening and flavoring cold and hot cereals. The instant invention fulfills this need. With the instant invention, consumers will be able to choose ‘healthy’ cold or hot cereals that are normally considered boring to children and adults (for example made from whole grains without added sugar) and easily and inexpensively make them as appealing or more appealing than the ‘unhealthy’ cereals (for example made with a very high sugar content).

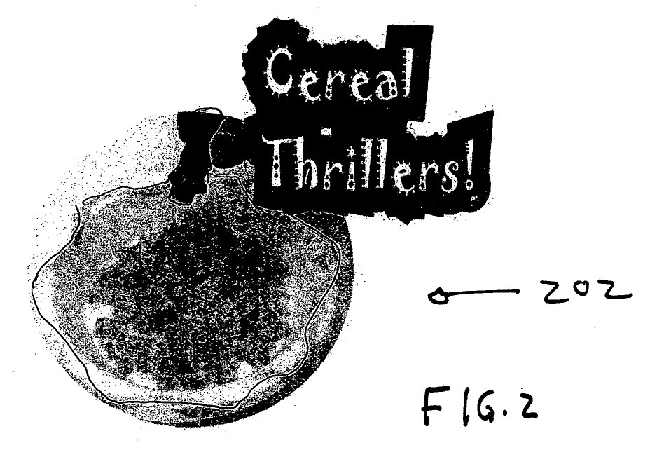

Referring to FIG. 2, cereal drops 202 have been developed that are a flavored liquid that is applied to the cereal to enhance flavor. The flavoring and any other active ingredients may be highly concentrated. The liquid may be in a container which delivers unit doses, such as a container with a spray head such as a finger pump, or such as a container with a dropper head to create drops when the container is up-ended and squeezed (see above). The liquid may also contain sweeteners to sweeten the cereal and heighten the flavor. If it is a fruit flavor, it is also possible for the liquid to contain acid to simulate the tartness of the fruit. The drops may flavor the cereal directly or may mix with any milk or cream or etc. which is placed on the cereal or both. The spray head, dropper head, etc. may be configured to give a relatively uniform size dose in each activation of the spray head or squeezed drop or etc., so that the effect of a single spray or drop or etc. on a given amount of base liquid is relatively predictable. The ingredients can include flavorants, acids, sweeteners, colorants, thickeners, surfactants, humectants, and any other type of ingredient as desired to affect the properties of the cereal. Flavorants should be included in the cereal drops to achieve a satisfactory result.

Example: The following ingredients are mixed and put into a small spray bottle with a finger pump. The raspberry flavor is #996.558/WC from Flavors of North America, Carol Stream, Ill.

| Weight (grams) | Material |
|---|---|
| 1.73 | Raspberry flavor |
| 0.04 | ascorbic acid |
| 0.38 | aspartame |
| 0.38 | acesulfame potassium |
| 0.13 | Sucralose |
| 5.73 | citric acid |
| 0.03 | food coloring, FD&C Blue #1 |
| 0.04 | glycerin |
| 0.01 | sodium benzoate |
| 5.97 | distilled water |

The ascorbic acid provides Vitamin C, the aspartame, acesulfame potassium, and Sucralose are artificial sweeteners, the citric acid provides the tartness usually associated with raspberries, the food coloring provides color, in this case the color often associated with raspberry candies rather than with fresh raspberries, the glycerin is a humectant that prevents drying (and resultant clogging) at the spray head or dropper head, and the sodium benzoate is an anti-microbial to ensure long shelf life.

Fifteen sprays of this example are put onto a bowl of Rice Chex cereal with milk, at one-inch intervals around the bowl from close proximity to the cereal. The result is fifteen spots of blue. The cereal is then lightly mixed with the milk. During this light mixing, the blue spots fade but remain, while the milk turns a light blue. The cereal and milk combination is highly flavored and sweetened with a very appealing raspberry flavor, but nearly zero calories are added (as compared with the typical process of sprinkling a heavy amount of table sugar onto the Rice Chex and milk). The process is very simple, makes no mess, is very inexpensive, consumes very little storage space and no counter or refrigerator space (can be stored in cupboard or pantry), is not subject to spoilage (shelf life is very high in comparison with fresh raspberries), is non-dangerous (no cutting of fruit), can be made always available without regard to season, and generates only the trash of a small container and then only after many uses. As raspberry flavoring is one example among thousands of flavoring options, the invention can satisfy the need for a high variety of flavors. Other flavor examples may include caramel-apple, pralines-and-caramel, chocolate, blueberry, strawberry, peach, banana, banana-nut, kiwi, orange, tangerine, pear, grape, and cinnamon.

Alternatively with this same example formulation, the solution above can be put into a squeezable plastic container (such as are used for eye drops and ear drops and food coloring drops) and dropped at intervals on the bowl of Rice Chex. An advantageous type of dropper bottle would be a “no-drip” design (such as that used by Gel Spice Co., Inc. of Bayonne, N.J. for its Spice Supreme Food Colors). Shown below is a bowl of Rice Chex with the drops of the example:

In either version of the example, artificial (or potent natural) sweeteners and concentrated flavors (artificial, natural, or a combination) can be used to create a highly concentrated liquid.

Even if a cereal already has flavors or sweeteners added by the manufacturer of the cereal, it may be desirable to use the flavored liquid doses of the instant invention to further enhance flavor or sweetness. For example, a chocolate-flavored liquid concentrate of the instant invention is an excellent addition to Captain Crunch's Peanut Butter Crunch Cereal.

Examples of hot cereals that can be enhanced by the instant invention include Malt-O-Meal, whole grain rolled oatmeal, Apple-Cinnamon Quaker Instant Oatmeal, Zoom, cream of wheat, Farina, grits, shredded wheat, and germade. Examples of cold cereals that can be enhanced by the instant invention include Cheerios, Rice Chex, Corn Chex, Wheat Chex, Kellogg's Corn Flakes, Kellogg's Frosted Mini-Wheats, shredded wheat, All-Bran, Raisin Bran, Captain Crunch, Sugar Smacks, Fruit Loops, and Boo-Berries.

Either of these two liquid dosage forms (sprayer and dropper), or other forms that can deliver a liquid for enhancing the flavor of hot or cold cereal, can be used, and the liquid can be formulated with any flavorants and other ingredients that meet the needs of the instant invention. The liquid can be applied in discrete places on the cereal to simulate cut fruit pieces or can be put into or onto any area of the cereal or can be put into or onto any area of the cereal and be stirred in or be used in any manner that will enhance the hot or cold cereal. Milk or cream or any other substance can also be added to the cold or hot cereal at the desire of the user. If the cereal is to be used as a finger food or snack, a drop or spray can be placed directly on the dry cereal and consumed. The definition of liquid in the instant invention also includes thickened or gelled liquids. For example a flavored liquid of my invention can be gelled to an elastomeric state and discrete chunks of the gel can be put onto the cereal.

Cereal drops provide, as desired, sweet, fruity or sour flavors on cereal without the mess and storage problems of real fruit. They add flavor and excitement to boring traditional cereals and enhance even kids cereal. Cereal drops can be provided without sugar to avoid dental decay and other deleterious health effects, and they can be used on hot or cold cereal.

For the readers reference, additional detail of components of some example cereal drops, cereal sprays, or more generically cereal thrillers are as follow:

CEREAL THRILLERS
BLUEBERRY and STRAWBERRY FLAVORS

| Wt.(gms) | Material | Identification | Source |
|---|---|---|---|
| STRAWBERRY | | | |
| 1.73 | strawberry | #EZ | Flavors of North |
| | flavor | 0004U.915/WC | America, Inc |
| 0.04 | ascorbic acid | Lot # 2959-J2 | Nature's Life |
| 0.04 | acesulfame | Sunett Brand | Nutrinova, Inc. |
| | potassium | Sweetner-sample | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Red #40, | Spectrum |
| | total | Lot # RG1249 | |
| 5.97 | distilled water | | Western Family |
| 0.96 | K-citrate | Lot # 260204-F | Stauber |
| | | | Performance |
| 0.96 | malic acid | Lot # 050304-D | Stauber |
| | | | Performance |
| BLUEBERRY | | | |
| 1.73 | blueberry | # 809.132/WC | Flavors of North |
| | flavor | | America, Inc |
| 0.04 | ascorbic acid | Lot # 2959-J2 | Nature's Life |
| 0.04 | acesulfame | Sunett Brand | Nutrinova, Inc. |
| | potassium | Sweetner-sample | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.97 | distilled water | | Western Family |
| 0.96 | K-citrate | Lot # 260204-F | Stauber |
| | | | Performance |
| 0.96 | malic acid | Lot # 050304-D | Stauber |
| | | | Performance |

Tongue Drops or Tongue Sprays

Children love intense flavor sensations. One means of providing such flavor sensations is to make extremely sour liquids which are delivered to the mouth in the form of a measured unit dose such as a spray from a spray bottle or a drop from a dropper bottle. While these ultra-high-acid formulations provide a shock value to the child, they do not provide a pleasing flavor sensation. Less sour formulations may be desirable, but may require intense sweetness. Because of the small volume of the unit dose (for example one drop from a dropper bottle), there is insufficient volume for the inclusion of sugar or corn syrup or other such sweetener. Yet the use of any single available artificial sweetener, when used at the levels needed to produce the desired intensity of flavor experience in a single drop dose, causes a bad aftertaste. The need exists for a measured-unit-dose liquid for dispensing in the mouth that provides highly intense but also highly pleasant flavoring experience, free from excess sourness or from a bad aftertaste.

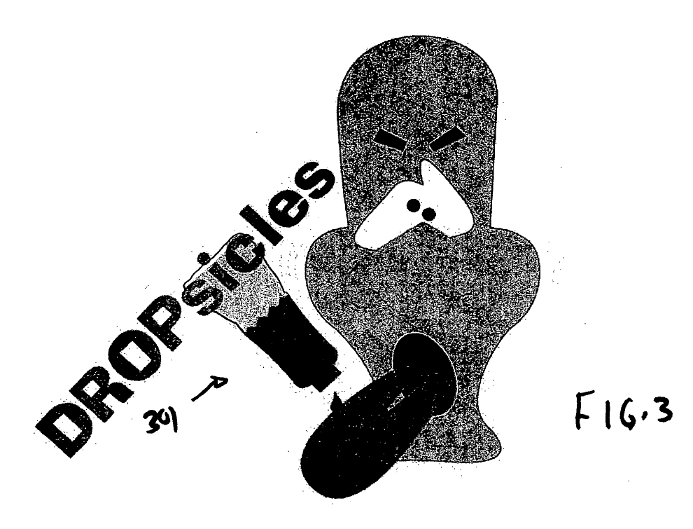

Referring to FIG. 3, dropsicles, tong drops or tongue sprays 301 are provided in a liquid delivered in unit doses to the mouth that provides pleasing but highly intense flavors by comprising highly concentrated flavorings balanced with a blend of two or more highly intense sweeteners. Where acid is used in certain flavors (such as fruit flavors) for tartness, it is to be offset with the sweeteners so as not to create too sour a flavor.

Example:

| Weight (grams) | Material |
|---|---|
| 6.61 | chocolate flavor |
| 0.73 | Aspartame |
| 0.73 | acesulfame potassium |
| 0.15 | Sucralose |
| 0.14 | Glycerin |
| 0.02 | sodium benzoate |
| 39.01 | distilled water |

The chocolate flavoring is from Harmony Concepts of Ogden, Utah. The aspartame, acesulfame potassium, and Sucralose are highly intense artificial sweeteners. The coconut oil is a fat that improves flavor and mouth feel. The vanilla is a spice that improves flavor. The salt improves flavor. The sodium benzoate is an anti-microbial to ensure long shelf life.

The mixture is dissolved into a solution and placed in a dropper bottle, then one drop in placed on the tongue. It provides an intense sweet chocolate flavor which lasts in the mouth for several minutes, slowly dissipating. The blend of three sweeteners greatly reduces (to a minority of people) or eliminates (to a majority of people) the bad aftertaste that would be experienced with the same overall sweetness level obtained from any one of these sweeteners alone.

The sweeteners need not be artificial, but do need to be intense in order to be effective in such a small unit dose as a drop or sprits. Natural sweeteners such as Stevia are also available, but also have an undesirable aftertaste unless used in combination with other sweeteners as disclosed in the instant invention.

Another Example:

| Weight (grams) | Material |
|---|---|
| 1.73 | raspberry flavor |
| 0.04 | ascorbic acid |
| 0.38 | Aspartame |
| 0.38 | acesulfame potassium |
| 0.13 | Sucralose |
| 5.73 | citric acid |
| 0.03 | food coloring |
| 0.04 | Glycerin |
| 0.01 | sodium benzoate |
| 35.76 | distilled water |

The raspberry flavoring is a highly concentrated flavor from Flavors of North America, designation 906.558/WC. The glycerin is a humectant that prevents drying (and resultant clogging). The ascorbic acid provides Vitamin C. Because this is a fruit flavor, tartness is desirable, and thus the citric acid; but to prevent an unpleasantness associated sourness, a high level of sweetener (again a blend of intense sweeteners to reduce or eliminate the aftertaste) is used to balance the citric acid.

The mixture is dissolved into a solution and placed in a finger-pump spray bottle, then one sprits is placed on the tongue. It provides an intense sweet-tart raspberry flavor which lasts in the mouth for several minutes, slowly dissipating. The blend of three sweeteners greatly reduces or eliminates the bad aftertaste that would be experienced with the same overall sweetness level obtained from any one of these sweeteners alone.

A wide variety of these intense flavorings with intense aftertaste-reducing sweetener blends can be used for the delight of the consumer, for example:
Grape
Raspberry
Orange
Lemon
Blueberry
Cherry
Watermelon
Strawberry
Apple
Kiwi Strawberry
Kiwi Banana
Kiwi Pineapple
Strawberry Orange
Orange Mango
Cherry Berry
Watermelon Raspberry
Lime
Lemon Lime
Citrus Blast
Tangerine
Orange Pineapple
Strawberry Banana
Orange Strawberry Banana
Melon Peach
Hawaiian Punch
Pink Lemonade
Bubble Gum
Cotton Candy
Orange Cream
Tutti Frutti
Red Hot
Strawberry Orange
Orange Mango
Cherry Berry
Watermelon Raspberry
Lime
Lemon Lime
Citrus Blast
Tangerine
Orange Pineapple
Strawberry Banana
Orange Strawberry Banana
Melon Peach
Chocolate
Chocolate Mint
Wintergreen
Spearmint
Peppermint
Candy Cane

Some example dropsicles tongue drops are described below:

Dropsicles Tongue Drops

| Wt.(gms) | Material | Identification | Source |
|---|---|---|---|
| CHOCOLATE | | | |
| 13.22 | Harmony | Lot # 210704-60 | Harmony |
| | chocolate | | Concepts, Inc. |
| | flavor | | |
| 0.28 | acesulfame | Sunett Brand | Nutrinova, Inc. |
| | potassium | Sweetner-sample | |
| 1.18 | sucralose | Lot # 180304-C | Tate & Lyle |
| | | | Sucralose Inc. |
| 0.30 | glycerine | CAS 56-81-5 | High Valley |
| | | | Chemical, Inc. |
| 77.74 | distilled water | | Western Family |
| 0.03 | sodium benzoate | Lot # RI2058 | Spectrum |
| 0.26 | carrageenan, | Coyote Stabilizer | Gum Technology |
| | xanthan | CX-BD-1 | |
| RASPBERRY | | | |
| 1.73 | raspberry | #906.558/WC | Flavors of North |
| | flavor | | America, Inc |
| 0.04 | ascorbic acid | 2959-J2 | Nature's Life |
| 0.10 | acesulfame | Sunett Brand | Nutrinova, Inc. |
| | potassium | Sweetner-sample | |
| 0.41 | sucralose | 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| 7.96 | distilled water | | Western Family |
| 7.98 | Konjac gum | Coyote Brand | Gum Technology |
| | | Konjac-A | |
| 0.64 | K-citrate | 260204-F | Stauber |
| | | | Performance |
| 3.82 | citric acid | CAS 77-92-9 | High Valley |
| | | | Chemical, Inc. |

Drops and Sprays for Breakfast Breads

As used herein, the term ‘breakfast breads’ (or breadstuffs) means waffles, pancakes, French toast, breakfast toast and the like which are traditionally consumed at breakfast.

Children and adults love pancakes or waffles or French toast that have sweet syrup (such as maple-flavored syrup) and that have fruit on or in them; they also love toasted or untoasted bread or rolls or other bread-type foods with sweet fruit-based jam or jelly However, the sweetness generally comes from sugar which many feel is not healthful in the large amounts that are contained in syrups, jams, and jellies. In the cases of putting actual fruits or sliced fruit on the breadstuff, the fruit is expensive and difficult to keep fresh and difficult or messy to apply. For example, children may cut themselves with a sharp knife while attempting to slice strawberries onto the breadstuff. As another example, a container of expensive blueberries may go moldy before all of the blueberries are used. The desired fruit may not be in season and thus difficult to obtain. Using fruit also creates a limitation on flavors to those that may desire other flavors on their cereal than fruit flavors. Fruit can also take up valuable refrigerator or counter space, especially if it is desirable to make a variety of fruits available to family members. Cutting a banana or other ripe fruit can be a messy process that leaves the hands slimy, and leaves trash to dispose of such as banana peels that can attract fruit flies. There exists a need for a simple, sugar-free or reduced sugar, non-messy, inexpensive, low-space-consuming, non-spoiling, non-dangerous, always available, high-flavor-variety, low-trash means of sweetening and flavoring breadstuff. The instant invention fulfills this need. With the instant invention, consumers will be able to apply sugar-free intense fruity or other flavor to their breadstuff in an easy non-messy manner, have a large variety of flavors to choose from in a small non-refrigerated space, and have intense sweetness without sugar.

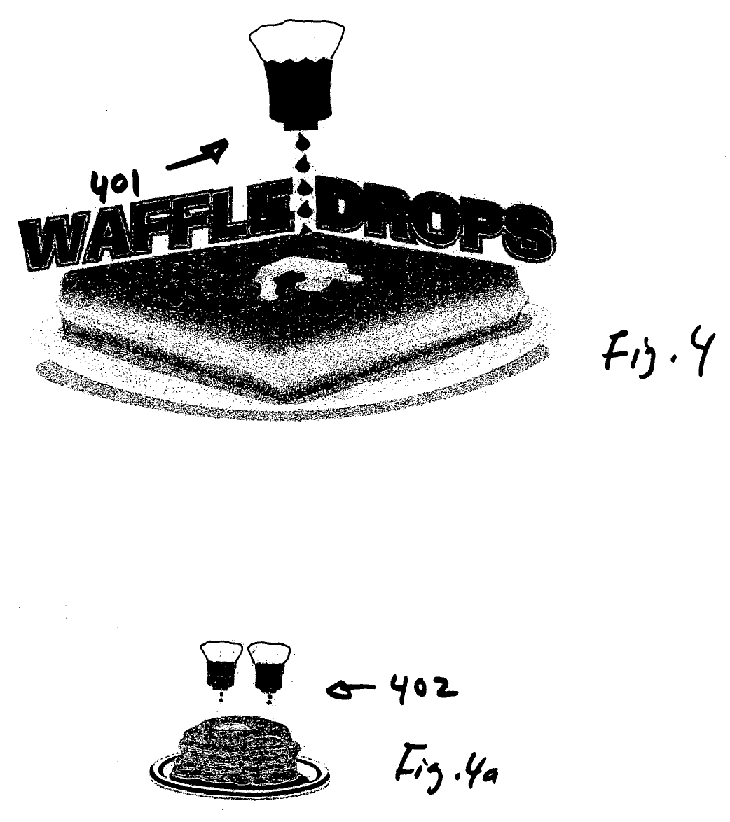

The instant invention is that of a flavored liquid that is applied to the breadstuff to enhance flavor. Referring to FIGS. 4 and 4a, waffle drops 401 and pancake drops 402 are depicted being applied to breakfast breads. The flavoring and any other active ingredients are highly concentrated. The liquid is in a container which delivers unit doses, such as a container with a spray head such as a finger pump, or such as a container with a dropper head to create drops when the container is up-ended and squeezed. The liquid may also contain sweeteners to sweeten the breadstuff and heighten the flavor. If it is a fruit flavor, the liquid can contain acid to simulate the tartness of the fruit. The spray head, dropper head, etc. may be configured to give a relatively uniform size dose in each activation of the spray head or squeezed drop or etc., so that the effect of a single spray or drop or etc. on a given amount of base liquid is relatively predictable. The ingredients can include flavorants, acids, sweeteners, colorants, thickeners, surfactants, humectants, and any other type of ingredient as desired to affect the properties of the breadstuff. Flavorants must be included in my invention.

Example: The following ingredients are mixed and put into a small spray bottle with a finger pump. The blueberry flavor is #809.132/WC from Flavors of North America, Carol Stream, Ill.

| Weight (grams) | Material |
|---|---|
| 11.60 | blueberry flavor |
| 0.40 | ascorbic acid |
| 2.60 | aspartame |
| 2.60 | acesulfame potassium |
| 0.90 | Sucralose |
| 38.20 | citric acid |
| 0.15 | food coloring total |
| 0.40 | glycerin |
| 0.10 | sodium benzoate |
| 59.70 | distilled water |

The ascorbic acid provides Vitamin C, the aspartame, acesulfame potassium, and Sucralose are artificial sweeteners, the citric acid provides the tartness usually associated with fruits, the food coloring provides color, the glycerin is a humectant that prevents drying (and resultant clogging) at the spray head or dropper head, and the sodium benzoate is an anti-microbial to ensure long shelf life.

Twenty sprays of this example are put onto a stack of two hot buttered waffles, at one-inch intervals around the upper of the two waffles from close proximity to the waffle. The result is twenty spots of blue. The waffles are highly flavored and sweetened with a very appealing blueberry flavor, but nearly zero calories are added (as compared with the typical process of pouring a heavy amount of sugar-based maple syrup onto the waffles). The process is very simple, makes no mess, is very inexpensive, consumes very little storage space and no counter or refrigerator space (can be stored in cupboard or pantry), is not subject to spoilage (shelf life is very high in comparison with fresh blueberries), is non-dangerous (no cutting of fruit), can be made always available without regard to season, and generates only the trash of a small container and then only after many uses. As blueberry flavoring is one example among thousands of flavoring options, the invention can satisfy the need for a high variety of flavors. Other flavor examples may include maple, caramel-apple, pralines-and-caramel, chocolate, blueberry, strawberry, peach, banana, banana-nut, kiwi, orange, tangerine, pear, grape, and cinnamon.

Alternatively with this same example formulation, the solution above can be put into a squeezable plastic container (such as are used for eye drops and ear drops and food coloring drops) and dropped at intervals on the breadstuff—see illustration below. An advantageous type of dropper bottle would be a “no-drip” design (such as that used by Gel Spice Co., Inc. of Bayonne, N.J. for its Spice Supreme Food Colors).

In either version of the example, artificial (or potent natural) sweeteners and concentrated flavors (artificial, natural, or a combination) are preferred to create a highly concentrated liquid.

Even if a breadstuff already has flavors or sweeteners added by the maker of the breadstuff or by the consumer, it may be desirable to use the flavored liquid doses of the instant invention to further enhance flavor or sweetness. For example, a chocolate-flavored liquid concentrate of the instant invention is an excellent addition to maple syrup on pancakes. As another example, if a pancake mix is used which already contains blueberries, a maple flavored solution of the instant invention would be an excellent addition to buttered or unbuttered blueberry pancakes.

Either of these two liquid dosage forms (sprayer and dropper), or other forms that can deliver a liquid for enhancing the flavor of breadstuff, can be used, and the liquid can be formulated with any flavorants and other ingredients that meet the needs of the instant invention. The liquid can be applied in discrete places on the breadstuff to simulate cut fruit pieces or can be put into or onto any area of the breadstuff or be used in any manner that will enhance the breadstuff.

The use of drops and sprays for breakfast breads enables a user to create a flavor explosion on an otherwise bland traditional product. The drops may be sugar free and are simple without any messy effects of syrup, honey or fruit.

Example drops and sprays for breakfast breads are as follow:

DROPS AND SPRAYS FOR BREAKFAST BREADS
BLUEBERRY and STRAWBERRY FLAVORS

| Wt.(gms) | Material | Identification | Source |
|---|---|---|---|
| STRAWBERRY | | | |
| 1.73 | strawberry | #EZ | Flavors of North |
| | flavor | 0004U.915/WC | America, Inc |
| 0.04 | ascorbic acid | Lot # 2959-J2 | Nature's Life |
| 0.04 | acesulfame | | |
| | potassium | | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.96 | distilled water | | Western Family |
| 0.01 | Konjac gum | Coyote Brand | Gum Technology |
| | | Konjac-A | |
| 0.96 | K-citrate | Lot # 260204-F | Stauber |
| | | | Performance |
| 0.24 | citric acid | CAS 77-92-9 | High Valley |
| | | | Chemical, Inc. |
| 0.72 | malic acid | Lot # 050304-D | Stauber |
| | | | Performance |
| BLUEBERRY | | | |
| 1.73 | blueberry | # 809.132/WC | Flavors of North |
| | flavor | | America, Inc |
| 0.04 | ascorbic acid | Lot # 2959-J2 | Nature's Life |
| 0.04 | acesulfame | | |
| | potassium | | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.96 | distilled water | | Western Family |
| 0.01 | Konjac gum | Coyote Brand | Gum Technology |
| | | Konjac-A | |
| 0.96 | K-citrate | Lot # 260204-F | Stauber |
| | | | Performance |
| 0.24 | citric acid | CAS 77-92-9 | High Valley |
| | | | Chemical, Inc. |
| 0.72 | malic acid | Lot # 050304-D | Stauber |
| | | | Performance |

Drops and Sprays for Ice Cream and Other Dairy Confections

Children and adults love ice cream that has sweet syrups (such as chocolate syrup or butterscotch syrup) and that have fruit on or in them (such as bananas); they also sweetened toppings with or without fruit for other dairy-based desserts such as cheesecake with cherry pie filling (for simplicity I will hereafter refer to all of these and other potential bases as dairy desserts.) However, the sweetness generally comes from sugar which many feel is not healthful in the large amounts that are contained in syrups, pie fillings, etc. In the cases of putting actual fruits or sliced fruit on the dairy desserts, the fruit is expensive and difficult to keep fresh and difficult or messy to apply. For example, children may cut themselves with a sharp knife while attempting to slice fruit onto the dairy dessert. As another example, a bunch of expensive bananas may go bad before all of the bananas are used. The desired fruit may not be in season and thus difficult to obtain. Cutting a banana or other ripe fruit can be a messy process that leaves the hands slimy, and leaves trash to dispose of such as banana peels that can attract fruit flies. There exists a need for a simple, sugar-free or reduced sugar, non-messy, inexpensive, non-spoiling, non-dangerous, always available, high-flavor-variety, low-trash means of sweetening and flavoring breadstuff. The instant invention fulfills this need. With the instant invention, consumers will be able to apply sugar-free intense flavors to their dairy desserts in an easy non-messy manner, have a large variety of flavors to choose from, and have intense sweetness without sugar.

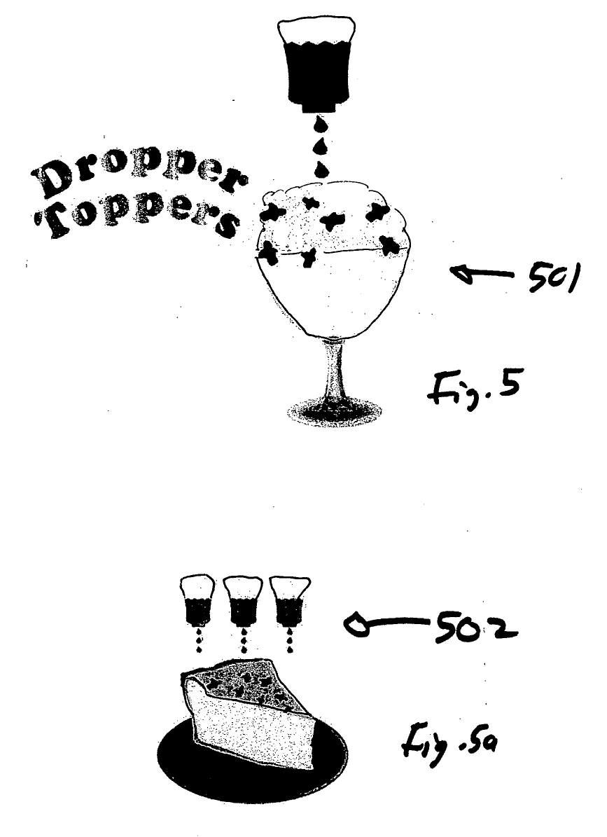

Referring to FIGS. 5 and 5a, dropper toppers 501 and 502 (drops/spray for dairy desserts) are depicted for ice cream and cheesecake respectively where they will add delicious flavoring for the enjoyment of a consumer. The flavoring and any other active ingredients are highly concentrated. The liquid is in a container which delivers unit doses, such as a container with a spray head such as a finger pump, or such as a container with a dropper head to create drops when the container is up-ended and squeezed. It is preferable that the liquid also contains sweeteners to sweeten the dairy dessert and heighten the flavor. If it is a fruit flavor, it is generally also the case that the liquid contain acid to simulate the tartness of the fruit. The spray head, dropper head, etc. may be configured to give a relatively uniform size dose in each activation of the spray head or squeezed drop or etc., so that the effect of a single spray or drop or etc. on a given amount of base liquid is relatively predictable. The ingredients can include flavorants, acids, sweeteners, colorants, thickeners, surfactants, humectants, and any other type of ingredient as desired to affect the properties of the breadstuff. Flavorants must be included in my invention.

Example: The following ingredients are mixed and put into a small dropper bottle.

| Weight (grams) | Material |
|---|---|
| 66.08 | chocolate flavor |
| 7.34 | aspartame |
| 7.34 | acesulfame potassium |
| 2.45 | Sucralose |
| 1.45 | glycerin |
| 0.30 | sodium benzoate |
| 130.20 | distilled water |

The chocolate flavoring is from Harmony Concepts of Ogden, Utah. The aspartame, acesulfame potassium, and Sucralose are artificial sweeteners. The glycerin prevents drying and associated clogging. The sodium benzoate is an anti-microbial to ensure long shelf life. It is also advantageous to add fat such as coconut oil, vanilla, and salt, which combine to improve the flavor of the chocolate.

Ten sprays of this example are put onto a dish of vanilla ice cream, at half-inch intervals across the top of the ice cream from close proximity to the ice cream. The result is ten spots of brown. The ice cream is highly flavored and sweetened with a very appealing chocolate flavor, but nearly zero calories are added (as compared with the typical process of pouring a heavy amount of high-calorie chocolate syrup onto the waffles). The process is very simple, makes no mess, is very inexpensive, consumes very little storage space and no counter or refrigerator space (can be stored in cupboard or pantry), is not subject to spoilage, is non-dangerous), can be made always available without regard to season, and generates only the trash of a small container and then only after many uses. As chocolate flavoring is one example among thousands of flavoring options, the invention can satisfy the need for a high variety of flavors. Other flavor examples may include caramel, butterscotch, strawberry, and blueberry.

Alternatively with this same example formulation, the solution above can be put into a squeezable plastic container (such as are used for eye drops and ear drops and food coloring drops) and dropped at intervals on the dairy dessert—see illustration below. An advantageous type of dropper bottle would be a “no-drip” design (such as that used by Gel Spice Co., Inc. of Bayonne, N.J. for its Spice Supreme Food Colors). Shown below is an illustration of a bowl of ice cream with the drops of the example:

In either version of the example, artificial (or potent natural) sweeteners and concentrated flavors (artificial, natural, or a combination) are preferred to create a highly concentrated liquid.

Even if a dairy dessert already has flavors or sweeteners added by the maker of the dairy dessert or by the consumer, it may be desirable to use the flavored liquid doses of the instant invention to further enhance flavor or sweetness. For example, a chocolate-flavored liquid concentrate of the instant invention is an excellent addition to pralines-and-caramel ice cream. As another example, a blueberry flavored solution of the instant invention would be an excellent addition to chocolate ice cream.

A further example is putting drops of cherry flavored liquid of the instant invention onto New York style cheesecake.

Either of these two liquid dosage forms (sprayer and dropper), or other forms that can deliver a liquid for enhancing the flavor of dairy dessert, can be used, and the liquid can be formulated with any flavorants and other ingredients that meet the needs of the instant invention. The liquid can be applied in discrete places on the dairy dessert to simulate cut fruit pieces or can be put into or onto any area of the dairy dessert or be used in any manner that will enhance the dairy dessert.

Example ingredients for dropper toppers for dairy desserts are as follow:

DROPPER TOPPERS FOR DAIRY DESSERTS
STRAWBERRY, BLUEBERRY
and CHOCOLATE FLAVORS

| Wt.(gms) | Material | Identification | Source |
|---|---|---|---|
| STRAWBERRY | | | |
| 1.73 | strawberry | #EZ | Flavors of North |
| | flavor | 0004U.915/WC | America, Inc |
| 0.04 | ascorbic acid | Lot # 2959-J2 | Nature's Life |
| 0.04 | acesulfame | Sunett Brand | Nutrinova, Inc. |
| | potassium | Sweetner-sample | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.96 | distilled water | | Western Family |
| 0.01 | Konjac gum | Coyote Brand | Gum Technology |
| | | Konjac-A | |
| 0.96 | K-citrate | Lot # 260204-F | Stauber |
| | | | Performance |
| 0.24 | citric acid | CAS 77-92-9 | High Valley |
| | | | Chemical, Inc. |
| 0.72 | malic acid | Lot # 050304-D | Stauber |
| | | | Performance |
| BLUEBERRY | | | |
| 1.73 | blueberry | # 809.132/WC | Flavors of North |
| | flavor | | America, Inc |
| 0.04 | ascorbic acid | Lot # 2959-J2 | Nature's Life |
| 0.04 | acesulfame | Sunett Brand | Nutrinova, Inc. |
| | potassium | Sweetner-sample | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.96 | distilled water | | Western Family |
| 0.01 | Konjac gum | Coyote Brand | Gum Technology |
| | | Konjac-A | |
| 0.96 | K-citrate | Lot # 260204-F | Stauber |
| | | | Performance |
| 0.24 | citric acid | CAS 77-92-9 | High Valley |
| | | | Chemical, Inc. |
| 0.72 | malic acid | Lot # 050304-D | Stauber |
| | | | Performance |
| CHOCOLATE | | | |
| 6.61 | Harmony | Lot # 210704-60 | Harmony |
| | chocolate | | Concepts, Inc. |
| | flavor | | |
| 0.14 | acesulfame | Sunett Brand | Nutrinova, Inc. |
| | potassium | Sweetner-sample | |
| 0.59 | sucralose | Lot # 180304-C | Tate & Lyle |
| | | | Sucralose Inc. |
| 0.15 | glycerine | CAS 56-81-5 | High Valley |
| | | | Chemical, Inc. |
| 0.05 | food coloring | FD& C Red #40, | Spectrum |
| | | Lot #RG1249 | |
| 0.02 | food coloring | FD& C Blue #1, | Spectrum |
| | | Lot #Rg0809 | |
| 0.05 | food coloring | FD& C Yellow #6, | Spectrum |
| | | Lot #QJ1241 | |
| 16.57 | distilled water | | Western Family |
| 2.93 | Carrageenan, | Coyote Stabilizer | Gum Technology |
| | Xanthan | CX-BD-1 | |
| 0.02 | sodium benzoate | Lot # RI2058 | Spectrum |

MMMilk Drops

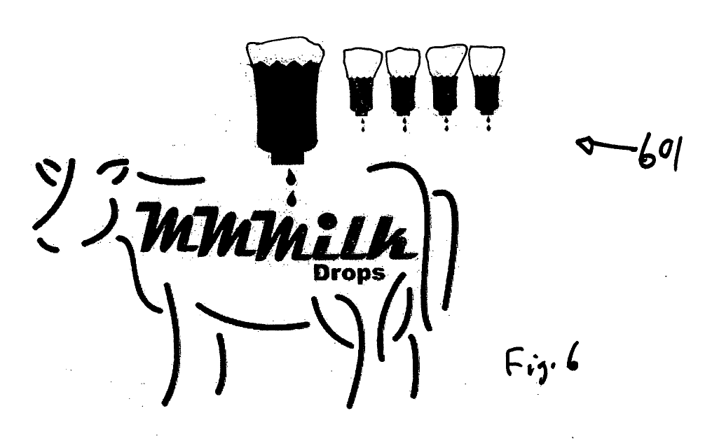

FIG. 6 depicts milk drops 601 which may be added to a beverage base such as milk or any milk substitute. Generally the principles disclosed elsewhere herein may be followed including the inclusion of flavoring, such as chocolate, raspberry, blueberry, strawberry, apple, pralines and caramel. The mmmilk drops may be sugar free. The consumer only needs to drop one or more mmmilk drops into a pre-determined quantity of beverage base such as milk, stir or mix, and enjoy an unprecedented sensation of flavor satisfaction that can overcome any craving. Children will enjoy using mmmilk drops, which will help them to consume a much needed food (milk).

Example mmmilk drops are described below:

MMMilk DROPS
CHOCOLATE, BLUEBERRY
and STRAWBERRY FLAVORS

| Wt.(gms) | Material | Identification | Source |
|---|---|---|---|
| STRAWBERRY | | | |
| 1.73 | strawberry | #EZ | Flavors of North |
| | flavor | 0004U.915/WC | America, Inc |
| 0.04 | ascorbic acid | Lot # 2959-J2 | Nature's Life |
| 0.04 | acesulfame | Sunett Brand | Nutrinova, Inc. |
| | potassium | Sweetner-sample | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.97 | distilled water | | Western Family |
| 0.96 | K-citrate | Lot # 260204-F | Stauber |
| | | | Performance |
| 0.96 | malic acid | Lot # 050304-D | Stauber |
| | | | Performance |
| BLUEBERRY | | | |
| 1.73 | strawberry | # 809.132/WC | Flavors of North |
| | flavor | | America, Inc |
| 0.04 | ascorbic acid | Lot # 2959-J2 | Nature's Life |
| 0.04 | acesulfame | Sunett Brand | Nutrinova, Inc. |
| | potassium | Sweetner-sample | |
| 0.35 | sucralose | Lot # 180304-C | Tate & Lyle |
| | | | Sucralose Inc. |
| 0.04 | glycerine | CAS 56-81-5 | High Valley |
| | | | Chemical, Inc. |
| 0.02 | food coloring | FD& C Blue #1 | Spectrum |
| | total | | |
| 5.97 | distilled water | | Western Family |
| 0.96 | K-citrate | Lot # 260204-F | Stauber |
| | | | Performance |
| 0.96 | malic acid | Lot # 050304-D | Stauber |
| | | | Performance |
| CHOCOLATE | | | |
| 6.61 | Harmony | Lot # 210704-60 | Harmony |
| | chocolate | | Concepts, Inc. |
| | flavor | | |
| 0.14 | acesulfame | Sunett Brand | Nutrinova, Inc. |
| | potassium | Sweetner-sample | |
| 0.59 | sucralose | Lot # 180304-C | Tate & Lyle |
| | | | Sucralose Inc. |
| 0.15 | glycerine | CAS 56-81-5 | High Valley |
| | | | Chemical, Inc. |
| 0.05 | food coloring | FD& C Red #40, | Spectrum |
| | | Lot #RG1249 | |
| 0.02 | food coloring | FD& C Blue #1, | Spectrum |
| | | Lot #Rg0809 | |
| 0.05 | food coloring | FD& C Yellow #6, | Spectrum |
| | | Lot #QJ1241 | |
| 16.57 | distilled water | | Western Family |
| 2.93 | Carrageenan, | Coyote Stabilizer | Gum Technology |
| | Xanthan | CX-BD-1 | |
| 0.02 | sodium benzoate | Lot # RI2058 | Spectrum |

Three or More High Intensity Sweeteners in Combination

This invention includes and builds upon an aspect of this inventor's pending U.S. Patent Application 20030224090 entitled “Snacks of Orally Soluble Edible Films” filed 20 Dec. 2002, which is hereby incorporated by reference in its entirety. In that application, it refers to this aspect by stating: “[We have discovered that a tripartite admixture of three different sweeteners is highly effective at producing a desirable snack. Rather than mixing the sweeteners in equal amounts by weight or volume, we have found it particularly useful to mix them in equal amounts of sweetness potency.”

The reason for this usefulness is two-fold. First, each type of sweetener has a somewhat different sweetness profile, meaning that it sweetens the front end or middle or back end of a taste experience, and that it lingers or does not linger. Having a blend of three or more high intensity sweeteners rounds out the overall flavor profile so that the sweetness is there during the entire taste experience. Second, each high intensity sweetener has a threshold which if exceeded results in a bad aftertaste. Combining three or more sweeteners allows three or more times the sweetness before that threshold is crossed, or put another way, can result in little or no aftertaste in a formulation which would have bad aftertaste if only one or two artificial sweeteners were used.

Of particular value is a blend of equal sweetness values of aspartame, acesulfame potassium, and Sucralose. Since aspartame and acesulfame potassium are about 200 times sweeter than sucrose, and Sucralose is 600 times sweeter than sugar, the amounts of aspartame and acesulfame need to be about each three times as much as the amount of Sucralose in order to achieve equal levels of sweetness. An example blend is:

| | |
|---|---|
| Aspartame | 300 grams |
| Acesulfame Potassium | 300 grams |
| Sucralose | 100 grams |

It is not necessary that the sweetness contribution of each sweetener be precisely equal to the others in order to be in accordance with my invention, but it is optimum to have them equal since that results in little or no aftertaste in many formulations.

This invention of blending of three or more high intensity sweeteners (natural or artificial) can apply to a wide variety of food and edible products, including but not limited to flavor films, drinks, drink concentrates, chewable tablets, tablet coatings, milk flavoring drops, tea flavoring drops, coffee flavoring drops, soda flavoring drops, waffle and pancake flavoring drops, ice cream and dairy dessert flavoring drops, tubes filled with flavored gelled liquid, candy with exterior of flavored film of water soluble polymer, tongue drops, intensely sour effervescing candies, drops/sprays for waffles, pancakes, French toast, toasted bread, bread, breath mints, candy, pudding, syrup, low carbohydrate recipes, and the like.

While compositions and methods have been described and illustrated in conjunction with a number of specific ingredients, materials and configurations herein, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations of snacks described herein are to be considered in all respects as only illustrative, and not restrictive. All changes which come within the meaning and range of equivalency of the claims are to be embraced within their scope.

1. A method for a consumer to individually flavor his own dairy dessert prior to consumption comprising the steps of:
selecting dairy dessert to be consumed,
obtaining a quantity of liquid dessert flavoring liquid,
said liquid dessert flavoring liquid being liquid,
said liquid dessert flavoring liquid containing a highly concentrated flavoring,
said highly concentrated flavoring being excessively strong for direct consumption,
said liquid dessert flavoring liquid being contained in a reservoir of a container,
dispensing a desired quantity of said liquid dessert flavoring liquid directly onto said dairy dessert,
ingesting a quantity of said dairy dessert with liquid dessert flavoring liquid, and
enjoying the flavor of said liquid dessert flavoring liquid and said dairy dessert,
the flavor of said dairy dessert with liquid dessert flavoring liquid being strong enough for detection by a human palate, and
said flavor of said dairy dessert with liquid dessert flavoring liquid on it being different from the flavor of said dairy dessert absent said liquid dessert flavoring liquid.

2. A method as recited in claim 1 wherein said liquid dessert flavoring liquid contains a sweetener.

3. A method as recited in claim 1 wherein said liquid dessert flavoring liquid contain an ingredient selected from the group consisting of ascorbic acid, aspartame, acesulfame potassium, Sucralose, citric acid, glycerin and sodium benzoate.

4. A method as recited in claim 1 wherein said container is capable of dispensing small measured unit doses of liquid dessert flavoring liquid.

5. A method as recited in claim 4 wherein said measured unit doses are of a predetermined strength and amount to impart a desired flavoring effect to a dairy dessert.

6. A method as recited in claim 1 wherein said container is a squeeze bottle.

7. A method as recited in claim 1 wherein said container is a spray bottle.

8. A method as recited in claim 1 wherein said container includes a nozzle through which liquid dessert flavoring liquid may be dispensed when said container is squeezed by a human hand.

9. A method as recited in claim 1 further comprising a finger pump on said container for dispensing liquid dessert flavoring liquid from said container to said dairy dessert.

10. A method as recited in claim 1 further comprising a spray head on said container for dispensing liquid dessert flavoring liquid from said container to said dairy dessert.

11. A method as recited in claim 1 further comprising a squeeze dropper for dispensing liquid dessert flavoring liquid from said container to said dairy dessert.

12. A method as recited in claim 1 further comprising a dispenser on said container, said dispenser serving to provide a generally uniform dosage of liquid dessert flavoring liquid each time said dispenser is actuated.

13. A method as recited in claim 1 wherein said liquid dessert flavoring liquid include ingredients selected from the group consisting of acids, artificial sweeteners, natural sweeteners, colorants, thickeners, surfactants, and humectants.

14. A method as recited in claim 1 wherein said container is portable.

15. A method as recited in claim 14 wherein said container is sized to be able to be carried in a consumer's pocket.

16. A method as recited in claim 15 further comprising the step of removing said container of drink drops from the consumer's pocket prior to dispensing said liquid dessert flavoring liquid onto said dairy dessert.

17. A method as recited in claim 15 wherein said container has a greatest dimension of less than 4 inches.

18. A method as recited in claim 15 wherein said container has a greatest dimension of less than 3 inches.

19. A method as recited in claim 15 wherein said container has a greatest dimension of less than 2 inches.

20. A method for a consumer to enhance the flavor of a dairy dessert in his own home or in a restaurant comprising the steps of:
obtaining a desired dairy dessert in a consumer's home or in a restaurant,
obtaining a quantity of liquid dessert flavoring liquid,
said liquid dessert flavoring liquid containing a highly concentrated flavoring,
said highly concentrated flavoring being excessively strong for direct consumption,
said liquid dessert flavoring liquid being contained in a reservoir of a portable container,
dispensing a predetermined measure dose of said liquid dessert flavoring liquid onto said dairy dessert in said consumer's home or in a restaurant,
said consumer ingesting a quantity of said flavored dairy dessert, and
enjoying the surprisingly enhanced flavor of said flavored dairy dessert.

21. A method as recited in claim 20 wherein said dairy dessert is selected from the group consisting of ice cream, frozen yogurt, ice-cream-like dairy desserts, and cheesecake.

22. A flavoring as recited in claim 20 further comprising a buffer to increase pH of the mixture and stabilize it to avoid flavor degradation.

23. A flavoring as recited in claim 22 wherein said buffer is potassium citrate.

24. A flavoring as recited in claim 22 wherein said buffer sodium citrate.

25. A flavoring as recited in claim 20 wherein said sweetener contains a combination of Acesulfame potassium and Sucrlose to stabilize it against degradation.
